(19) United States
(12) Patent Application Publication
(10) Pub. No.: US 2026/0278837 A1
(43) Pub. Date: Sep. 17, 2026

(54) METHOD AND SYSTEM FOR DETECTING SMALL SHIP TARGETS IN THERMAL INFRARED IMAGES BASED ON HIERARCHICAL FEATURE ATTENTION NETWORK

(71) Applicant: SHANGHAI INSTITUTE OF TECHNICAL PHYSICS CHINESE ACADEMY OF SCIENCES, Shanghai (CN)

(72) Inventors: Fang Wang, Shanghai (CN); Shiji Wen, Shanghai (CN); Zeyi Yan, Shanghai (CN); Xuming Shi, Shanghai (CN); Guoliang Yuan, Shanghai (CN); Xiao Zhuo, Shanghai (CN); Jin Wang, Shanghai (CN); Zhuoyue Hu, Shanghai (CN); Hangyu Xu, Shanghai (CN); Fansheng Chen, Shanghai (CN); Zhiping He, Shanghai (CN); Weida Hu, Shanghai (CN)

(21) Appl. No.: 19/235,729

(22) Filed: Jun. 12, 2025

(30) Foreign Application Priority Data
Mar. 17, 2025 (CN) 202510311385.1

(51) Int. Cl. G06T 7/73; G06T 7/10

(52) U.S. Cl. CPC G06T 7/75; G06T 7/10; G06T 2207/10036; G06T 2207/10048; G06T 2207/20084; G06T 2207/30252

(57) ABSTRACT

A method and system for detecting small ship targets in thermal infrared images based on hierarchical feature attention network belongs to the field of satellite remote sensing image processing and application technology. The present disclosure constructs the first pixel level annotated three-channel infrared ship target detection image dataset based on SDGSAT-1. This dataset covers various scenarios and contains rich thermal information, and is more suitable for detecting small ships in thermal infrared images. Meanwhile, a network model based on hierarchical feature attention mechanism is constructed, which generates feature maps of different scales through multi-level detail enhancement processing. Multi-level long-distance information was extracted through a multi-level large kernel attention mechanism. By the multi-level fusion of feature maps at different scales, a predicted target probability map is generated to achieve fusion and interaction of different scales, enabling accurate location of ships.

### CROSS-REFERENCE TO RELATED APPLICATIONS

This application claims the priority and benefit of Chinese patent application No. 202510311385.1, filed on Mar. 17, 2025. The entirety of Chinese patent application No. 202510311385.1 is hereby incorporated by reference herein and made a part of this specification.

### TECHNICAL FIELD

The present disclosure relates to the technical field of satellite remote sensing image processing and application, specifically to a method and system for detecting small ship targets in thermal infrared images based on a hierarchical feature attention network.

### BACKGROUND ART

Accurate and reliable ship target detection is of great significance for ensuring stable economic development and maintaining maritime transportation safety. Through remote sensing images, a wide range of information can be obtained, which provides a potential solution for space-based ship detection. However, different Earth observation satellites often carry sensors with different band settings, and the image size is relatively large. In an image, detecting small ship targets becomes a challenging task due to the complex background environment, diversity of ship appearance and surrounding targets, and low image resolution. Therefore, establishing an intelligent ship detection method based on remote sensing images is of great significance in sustainable ocean management.

At present, the images used for ship detection are mainly concentrated in the visible light and infrared bands. In particular, visible light images are easily affected by weather changes. However, in SAR images, the temporal variations of natural factors such as weather and wind speed may result in uneven sea surface height, which is not conducive to the application of SAR images. The infrared band can penetrate the atmosphere more effectively, especially in marine environments where ships often generate significant differences in heat. Therefore, thermal infrared images may be easier to identify ships and less susceptible to the influence of the surrounding environment. The use of satellite infrared bands to identify ships is a typical infrared small target detection task (IRSTD), and traditional IRSTD methods include filter-based background methods (“Infrared small target detection via low-rank tensor completion with top-hat regularization,” IEEE Transactions on Geoscience and Remote Sensing, vol. 58, no. 2, pp. 1004-1016, 2019); local contrast-based methods (“A local contrast method for infrared small-target detection utilizing a tri-layer window,” IEEE Geoscience and Remote Sensing Letters, vol. 17, no. 10, pp. 1822-1826, 2020) and local rank-based methods (“Infrared small target detection via non-convex rank approximation minimization joint 1 2, 1 norm,” Remote Sensing, vol. 10, no. 11, pp. 1821, 2018) have made some progress. Due to the need for manual parameter design and threshold extraction, remote sensing images with complex environments exhibit limited performance and weak generalization ability. With the rapid development of deep learning, Hou et al. enhanced the contrast between targets and backgrounds in infrared images by using fully connected layers in skip connections (“ISTDU-Net: Infrared Small-Target Detection U-Net,” IEEE Geoscience and Remote Sensing Letters, vol. 19, pp. 1-5, 2022); To achieve interaction between low-level and high-level features, Li et al. proposed Dense Nested Attention Network (DNANet) and introduced Cascaded Channel and Spatial Attention Module (CSAM) to enhance multi-level features (“Dense nested attention network for infrared small target detection,” IEEE Transactions on Image Processing, vol. 32, no., pp. 1745-1758, 2023). Although convolutional neural networks (CNNs) are indeed effective in extracting local information, the extraction of remote information is crucial in the context of complex structures in remote sensing images. Wu et al. proposed the Space based Infrared Ship Small Target Dataset (NUDT-SIRST-Sea), introduced a hybrid encoder structure of Vision Transformer (ViT) and CNN, and constructed a multi-level TransUNet (MTU-Net) to extract features at all levels (“MTU-Net: Multilevel TransUNet for space-based infrared tiny ship detection,” IEEE Transactions on Geoscience and Remote Sensing, vol. 61, pp. 1-15, 2023). However, when extracting multi-level global information, the relationships between features at each level were not utilized.

So far, researchers have proposed many deep learning based ship detection methods, but there are still some obvious shortcomings: (1) the lack of the utilization of the model for the feature information of different scales in the global remote sensing images, which is not conducive to segment small target objects from the image. (2) Due to the limited quantity and quality of the dataset, the selection of different satellite bands can also affect the detection accuracy of the model. (3) Due to the complex background environment of the image and the diversity of surrounding targets, missed and false detections often occur during detection.

### SUMMARY

In response to the demand for information in the dataset for detecting small ship targets in thermal infrared images, as well as the problems of information loss and feature extraction in target detection models, the present disclosure provides a method and system for detecting small ship targets in thermal infrared images based on a hierarchical feature attention network. The present disclosure constructs a pixel level annotated three-channel infrared ship target detection dataset, providing rich thermal information and more accurate data support for feature extraction in subsequent deep learning models; The network model based on hierarchical feature attention mechanism plays a key role in the input, extraction, aggregation, and target localization of multi-scale features, achieving full extraction and efficient utilization of multi-level features, and thus achieving high-precision extraction and localization of ship contours.

To achieve the above technical objectives, the present disclosure adopts the following technical solutions:

A method for detecting small ship targets in thermal infrared images based on hierarchical feature attention network, including the following steps:
S1: Images of detection areas in three thermal infrared bands of SDGSAT-1 were collected to establish a pixel level annotated three-channel infrared ship target detection dataset.
S2: A hierarchical feature attention network was developed for thermal infrared image ship target detection. The process is divided into four stages: input stage, feature extraction stage, prediction stage, and localization stage, including:
S21: In the input stage, the obtained three-channel infrared ship target dataset is applied to multi-level detail enhancement process to generate feature maps of different scales;
S22: In the feature extraction stage, multi-level long-distance information is extracted from multi-scale feature maps, and the information is fused into feature maps of different scales to generate feature maps;
S23: In the prediction stage, feature maps of different scales containing long-distance information are fused to generate a predicted target probability map;
S24: In the location phase, the generated predicted target probability map is used to locate the ship target using the eight connected aggregation algorithm.

Preferably, for step S1, image data of three thermal infrared bands of SDGSAT-1 were collected and preprocessed to establish a pixel level annotated three-channel infrared ship target detection dataset, including the following steps:
S11: Thermal infrared images from three thermal infrared bands in SDGSAT-1 were simultaneously collected, combining the three thermal infrared bands to form a three-channel thermal infrared image dataset;
S12: Radiometric calibration on the images was performed to generate a three-channel thermal infrared image dataset with amplitude and brightness values;
S13: The SAM model was used to annotate ship targets and a pixel level annotated three-channel infrared ship target detection dataset was obtained. Each image in the dataset is a three-channel image composed of three thermal infrared bands.

Preferably, for step S21, in the input stage, multi-level detail enhancement processing is performed on the obtained dataset to generate feature maps of different scales, specifically:
S211: A multi-level detail enhancement module with a single input dual output processing structure was proposed;
S212: At different levels, the first output path sent it to the next level without any processes. The second output path obtained images of different scales through downsampling, and then extracted local features of the input images through different numbers of residual blocks;
S213: Local features of different scales were fused to generate feature maps of different scales at different levels.

Preferably, the second output path adopted a dual branch structure, each branch structure including a different number of residual blocks for extracting semantic and detail information of the image separately.

Preferably, for step S22, in the feature extraction stage, a multi-level encoder large kernel attention mechanism was adopted to extract multi-level long-distance information from multi-scale feature maps, and then fuse the long-distance information to generate feature maps of different scales containing long-distance information, specifically:
S221: Multi-level encoders encoded feature maps of different scales to generate multi-level features;
S222: The multi-level features output by the multi-level encoder with the feature maps of different scales obtained in the input stage were merged to obtain a new multi-scale feature map;
S223: The multi-level long-distance information was extracted from multi-scale feature maps through a multi-level large kernel attention mechanism;
S224: Multi-level long-distance information was aggregated into feature maps of different scales through feature concatenation operations, and decoders restored the feature maps of different scales, which contain long-distance information.

Preferably, for step S223, each hierarchical large kernel attention mechanism includes the following steps:
S2231: Multi-scale feature maps were reconstructed using convolutional layers with a stride equal to the size of the convolution kernel, unifying the dimensions of the feature maps according to:

$${V}_{i} = Conv ( {E}_{i} ; s = k s = R {F}_{i} )$$

where, Vᵢ denotes the feature map of the i-th scale of the reconstructed output, Eᵢ denotes the i-th scale of the input feature map, RFᵢ denotes the reduction factor of the i-th level feature. Conv denotes the standard convolution, s and ks denote the step size and convolution kernel size, respectively. The reduction factors used for feature maps of different scales are different.
S2232: The reconstructed multi-scale feature map was first subjected to batch normalization, and then the large kernel attention mechanism processed for pointwise convolution, large kernel convolution, and pointwise convolution again to extract multi-level long-distance information; In particular, the large kernel convolution was decomposed into three parts, and the LKA calculation formula for the large kernel convolution is:

$$LKA = DW ( DDW ( PW ( I ) ) ) ⊗ I$$

where I denotes the input of the large kernel convolution, DW denotes a deep convolution with a kernel size of (2d−1)×(2d−1), DW denotes a deep convolution with a kernel size of

$$[ \frac{K}{d} ] \times [ \frac{K}{d} ] ;$$

PW denotes a pointwise convolution with a kernel size of 1×1; D denotes the convolution dilation rate and K is a preset standard parameter.
S2233: The multi-level long-distance information was sent to a multi-layer perceptron for information enhancement, which includes 1×1 point convolution, 3×3 depth convolution, Gaussian error linear unit, and 1×1 point convolution.

Preferably, for step S23, in the prediction stage, feature maps of different scales containing long-distance information were fused to generate a predicted target probability map, specifically:
S231: Feature maps of different scales were upsampled to generate feature maps of unified dimensions at different scales;
S232: The attention mechanism was used to assign different weights to feature maps of different scales, and the weighted feature maps were added element by element to generate the final predicted target probability map.

$$β = Conv ( Conv ( GAP ( D ) ; ks = 1 ) ; ks = 1 )$$

$$γ = Conv ( Conv ( GMP ( D ) ; ks = 1 ) ; ks = 1 )$$

$$α = γ + β$$

where D denotes the feature maps of different scales, Conv denotes the standard convolution, ks=1 indicates that the size of the convolution kernel is 1×1, GAP denotes the global average pooling, GMP denotes the global maximum pooling, β and γ denote the adaptive parameters used for feature fusion.

Preferably, for step S24, during the location phase, the generated predicted target probability map was used to locate the ship target using the eight connected aggregation algorithm, specifically:
S241: Binary the predicted target probability map using a preset threshold to generate a binary map;
S242: Use the eight connected aggregation algorithm to count the pixels contained in each ship target in the binary graph, and complete the ship target localization.

Preferably, based on the determination of the ship target, calculating and determining a centroid coordinates of the ship target with a weighted centroid location algorithm, the weighted centroid location algorithm is specifically: obtaining horizontal and vertical coordinate information of all pixels contained in the already located ship target, normalizing pixel values of all pixels of the ship target to obtain weights, and calculating the centroid coordinates of the ship target based on the weights and the horizontal and vertical coordinate information.

Preferably, the constructed network model based on hierarchical feature attention mechanism adopts a deep supervision strategy to evaluate the model. By adding loss functions in each level of the network model, the network model can learn discriminative features at different scales, aggregate the final output loss values of different levels, and then adjust the network model parameters to reduce the loss values and improve the model performance.

The present disclosure also provides a system for detecting small ship targets in thermal infrared images based on hierarchical feature attention network using the aforementioned method, including a thermal infrared image data processing module and a ship target recognition module;
the thermal infrared image data processing module preprocesses the image data of the three thermal infrared bands of SDGSAT-1 and outputs the pixel level annotated three-channel infrared ship target detection dataset;
the ship target recognition module is configured to construct the network model based on hierarchical feature attention mechanism for thermal infrared image ship target recognition, and includes a multi-level detail enhancement module, a multi-level large kernel attention module, a multi-level feature fusion module, and a ship target positioning module;
the multi-level detail enhancement module is applied in the input stage and generates the feature maps of different scales by performing a multi-level detail enhancement processing on the three-channel infrared ship target dataset;
the multi-level large kernel attention module is applied in the feature extraction stage and extracts the multi-level long-distance information from the multi-scale feature map with the multi-level large kernel attention mechanism, and then fuses the long-distance information into the feature maps of different scales to generate the feature maps of different scales containing long-distance information;
the multi-level feature fusion module is applied in the prediction stage and generates the predicted target probability map by fusing the feature maps of different scales containing long-distance information;
the ship target positioning module is applied in the localization stage and locates the ship target by using the generated predicted target probability map with the eight connected aggregation algorithm, and locates the centroid coordinates of the ship with the weighted centroid positioning algorithm

Compared with the existing technology, the beneficial effects generated by the present disclosure are:
1) The present disclosure combines the thermal infrared image data of SDGSAT-1 to construct the first pixel level annotated three-channel infrared ship target detection image dataset based on SDGSAT-1. Compared to other mainstream datasets, this dataset has the highest imaging width, smallest target size, largest image size, smallest average target to background ratio, most complex observation scenes, and the largest number of bands, making it more suitable for detecting small ship targets in thermal infrared images. The three thermal infrared bands of this dataset can be displayed synchronously in the image, providing rich thermal information and strong support for the subsequent deep learning models to fully extract thermal information.
2) The present disclosure constructs a network model based on hierarchical feature attention mechanism. In the input stage of the network model, multi-level detail enhancement processing is used to fuse local features of different scales with images of different sizes, generating feature maps of different scales, enhancing the representation of detail information at different scales, effectively compensating for useful information that may be lost during the downsampling process, and providing richer and more accurate data support for the next step of feature extraction; In the feature extraction stage, multi-level large kernel attention mechanism is used to extract multi-level long-distance information. The multi-layer large kernel attention mechanism can comprehensively capture and utilize global information from multiple levels while reducing computational complexity. This compensates for the shortcomings of convolutional neural network models that only focus on local features, enabling the model to learn the relationship between targets and backgrounds at different scales, effectively suppressing the interference of complex background environments and the diversity of surrounding targets on ship detection; In the prediction stage, different scale feature maps are fused to generate the final predicted target probability map, achieving feature fusion and interaction at different scales, which can significantly improve segmentation accuracy and enhance the comprehensive representation ability of details and global information, effectively improving the adaptability of the model to complex scenes. Finally, in the positioning stage, accurate extraction and positioning of the ship shape are achieved through the eight connected aggregation algorithm and weighted centroid positioning algorithm. Compared with existing convolutional neural network models, the network model proposed in this disclosure exhibits better performance in ship target detection tasks, with key indicators such as detection accuracy (P_{d}), false alarm rate (Fₐ), and intersection to union ratio (IoU) significantly better than existing network models.

### BRIEF DESCRIPTION OF THE DRAWINGS

FIG. 1 shows a flowchart of a method for detecting small ship targets in thermal infrared images based on hierarchical feature attention network of the present disclosure.

FIG. 2 shows the three-channel images of the SDG-IRSTD dataset in Example 2 of the present disclosure;

FIG. 3 shows a single channel image of the NUDT-SIRST Sea dataset in Example 2 of the present disclosure;

FIG. 4 shows the target size distribution bar chart of six datasets in Example 2 of the present disclosure;

FIG. 5 shows a bar chart of the distribution of target quantities for six datasets in Example 2 of the present disclosure;

FIG. 6 shows the target background ratio distribution bar chart for six datasets in Example 2 of the present disclosure;

FIG. 7 shows the overall structure of a micro ship target detection system in thermal infrared images based on a hierarchical feature attention network of the present disclosure.

### DETAILED DESCRIPTION

The technical solutions in the embodiments of the present disclosure are clearly and completely described in conjunction with FIGS. 1-7. Obviously, the described embodiments are only a part of the embodiments of the present disclosure, not all of them. Based on the embodiments of the present disclosure, all other embodiments obtained by ordinary skilled persons in the art without creative labor are within the scope of protection of the present disclosure.

### Example 1

As shown in FIG. 1, an Example of the present disclosure provides a method for detecting small ship targets in thermal infrared images based on a hierarchical feature attention network, including the following steps:
S1: Collect image data of detection areas in three thermal infrared bands of SDGSAT-1 and preprocess it to establish a pixel level annotated three-channel infrared ship target detection dataset;
S2: Construct a network model based on hierarchical feature attention mechanism, and use this network model for small target recognition of ships in thermal infrared images. The network is divided into four stages: input stage, feature extraction stage, prediction stage, and localization stage, which specifically includes:
S21: In the input stage, the obtained three-channel infrared ship target dataset is applied to multi-level detail enhancement process to generate feature maps of different scales;
S22: In the feature extraction stage, multi-level long-distance information is extracted from multi-scale feature maps, and the information is fused into feature maps of different scales to generate feature maps;
S23: In the prediction stage, feature maps of different scales containing long-distance information are fused to generate a predicted target probability map;
S24: In the localization stage, the generated predicted target probability map is used to locate the ship target using the eight connected aggregation algorithm.

### Example 2

On the basis of Example 1, this Example provides a detailed explanation of the implementation of generating pixel level annotations for the three-channel infrared ship target detection dataset in Step S1.

In this Example, for step S1, the detection area image data of three thermal infrared bands of SDGSAT-1 are collected and preprocessed to establish a pixel level annotated three-channel infrared ship target detection dataset, which specifically includes the following steps:
S11: Simultaneously collect thermal infrared image data from three thermal infrared bands in SDGSAT-1, combine the three bands to form a three-channel thermal infrared image dataset, which facilitates subsequent dataset production. In particular, SDGSAT-1 is a sustainable development satellite launched by China that can simultaneously carry three payloads: thermal infrared, low light, and multispectral imaging. SDGSAT-1 has three thermal infrared detection bands, which work synchronously. The spatial resolution of the three thermal infrared band data collected by SDGSAT-1 is 30 meters, and it can distinguish temperature differences of 0.2 degrees Celsius in a large dynamic range, which is helpful for infrared small target detection tasks (IRSTD).
S12: Perform radiometric calibration on the collected three-channel thermal infrared image dataset to generate a three-channel thermal infrared image dataset with amplitude and brightness values. Because the thermal infrared image data obtained by the sensor of SDGSAT-1 is a raw, unprocessed pixel value that cannot directly reflect any physical meaning, that is, it does not have dimensions. Therefore, it is necessary to convert the obtained pixel values into amplitude brightness values with practical physical significance through radiometric calibration. The calculation formula is:

$$L = GAIN \cdot DN + BIAS$$

where L denotes the radiance value, GAIN and BIAS denote the gain coefficient and bias coefficient of the corresponding frequency band, respectively.
S13: Use the SAM model to annotate ship targets in the thermal infrared image dataset using a semi-automatic annotation method. The SAM model is a large model tool that supports multiple segmentation types. The SAM model can automatically identify ship targets through point selection or box selection, and generate corresponding masks and bounding boxes. However, the SAM model may encounter annotation errors when processing some images. Therefore, for the problematic data, manual refinement is carried out to ensure the quality of the dataset, resulting in a pixel level annotated three-channel infrared ship target detection dataset. Each image in the dataset is a three-channel image composed of three thermal infrared components.

The following will further illustrate the implementation of a three-channel infrared ship target detection dataset for generating pixel level annotations through specific examples, and compare it with other conventional ship target detection datasets to demonstrate the technical effects brought by the present disclosure:
The collected thermal infrared image data comes from the Thermal Infrared Spectrometer (TIS) band images of SDGSAT-1. SDGSAT-1, also known as Sustainable Development Satellite 1, is the first scientific satellite launched to meet the data coverage requirements for sustainable development applications. SDGSAT-1 is equipped with three payloads: thermal infrared, low light, and multispectral imaging, which can achieve all-weather and multi payload collaborative observation. The revisit period of SDGSAT-1 is about 11 days, the spatial resolution of TIS band is 30 m, the imaging width can reach 300 km, and it has 3 detection bands. Its specific parameters are shown in Table 1.

TABLE 1

| Bands | Wavelength | Gain | Bias |
|---|---|---|---|
| TIS-1 | 8.0-10.5 μm | 0.003947 | 0.167126 |
| TIS-2 | 10.3-11.3 μm | 0.003946 | 0.124622 |
| TIS-3 | 11.5-12.5 μm | 0.005329 | 0.222530 |

Among the three bands in the table, TIS-1 (8.0-10.5 μm) is mainly used to monitor surface temperature and thermal distribution. This spectral range is highly sensitive to surface radiation and can accurately reflect changes in surface temperature. The TIS-2 (10.3-11.3 μm) spectral range has high penetration ability for water vapor and clouds in the atmosphere, making it suitable for monitoring atmospheric temperature and humidity. TIS-3 (11.5-12.5 μm) spectral range has high sensitivity to greenhouse gases such as carbon dioxide in the surface and atmosphere, and can be used for monitoring and studying greenhouse gas concentrations. The comprehensive application of long wave infrared bands enables thermal infrared imaging to accurately capture thermal radiation information.

In the specific implementation process, the three synchronized TIS bands in the collected thermal infrared image data are combined, and then combined with the values in Table 1 for radiometric calibration processing and ship target annotation. Finally, a pixel level annotated three-channel infrared ship target detection image dataset is established, referred to as the SDG-IRSTD dataset. The SDG-IRSTD dataset of this Example collected a total of 329 images from SDGSAT-1, including 3492 ship targets. Each image has a size of 1024×1024 and is composed of TIS1-TIS3.

Compared with four existing publicly available datasets (NUST-SIRST, IRSTD-1k, NUDT-SIRST, and NUDT-SIRST Sea), where NUST-SIRST (Wang et al., 2019, Miss detection vs. false alarm: adversarial learning for small object segmentation in infrared images.) A dataset containing 428 real and synthesized infrared images with resolutions ranging from 256×256 to 512×512 pixels; IRSTD-1k (Zhang et al., 2022, ISNet: shape matters for infrared small target detection) is a dataset containing 1000 images with a resolution of 512×512 for infrared small target detection; NUDT-SIRST (Li et al., 2022, Dense nested attention network for infrared small target detection) is a dataset containing 1327 infrared small target images with a resolution of 256×256; NUDT-SIRST Sea (Wu et al., 2023, MTU Net: multilevel TransUNet for space-based infrared tiny ship detection) is an infrared dataset containing 17598 images with a resolution of 1024×1024, used for detecting small ship targets. The comparison results are shown in Table 2.

TABLE 2

| | | Average | | | |
|---|---|---|---|---|---|
| | | Target/ | | | |
| | | Back- | | | |
| | | ground | Average | | |
| | | ratio | target | Image | Band |
| Dataset | Type | (%) | size | size | numbers |
| NUST-SIRST | synthetic | 0.23709 | 38 | 128 × 128 | 1 |
| IRSTD-1k | real | 0.02860 | 50 | 512 × 512 | 1 |
| NUDT-SIRST | synthetic | 0.06629 | 31 | 256 × 256 | 1 |
| NUDT-SIRST- | real | 0.03101 | 38 | 1024 × 1024 | 1 |
| Sea | | | | | |
| SDG-IRSTD | real | 0.02654 | 23 | 1024 × 1024 | 3 |

It can be seen from Table 2 that compared to the other five mainstream datasets, SDG-IRSTD has the highest imaging width, smallest target size, largest image size, and the greatest number of bands, making it more suitable for IRSTD tasks. Most other mainstream infrared small target detection datasets are single channel images, which only contain information from one band.

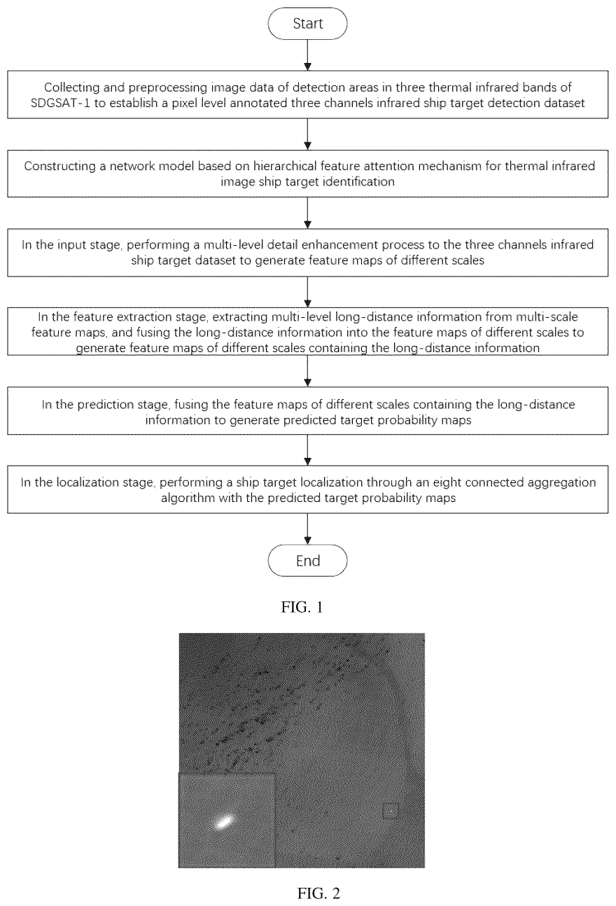

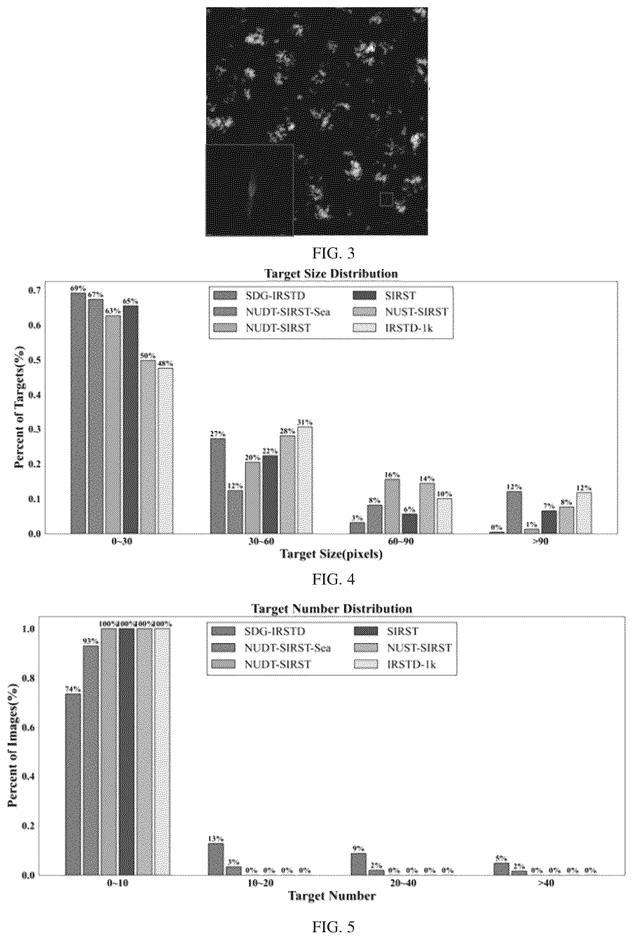

By comparing the effects of FIGS. 2 and 3, it can be seen that the SDG-IRSTD three-channel image dataset proposed by the present disclosure can display the three thermal infrared bands synchronously, and the thermal information in the image is more abundant. Therefore, the target brightness is stronger. Multiple thermal infrared bands can help discover the thermal characteristics of small targets on ships, while more bands are beneficial for ship detection.

As shown in FIG. 4, the target sizes of the SDG-IRSTD dataset are concentrated between and 30, accounting for 69% of the total targets. The other four mainstream datasets account for 67% (NUDT-SIRST Sea), 63% (NUDT-SIRST), 65% (SIRST), 50% (NUST-SIRST), and 48% (IRSTD-1k), respectively. Combined with Table 2, it can be seen that the average target size of the SDG-IRSTD dataset is 23, which has the smallest average size. The average target size of the other four mainstream datasets is about 1.3-2.2 times that of the SDG-IRSTD dataset. Based on the above analysis, the overall targets of the SDG-IRSTD dataset are smaller than those of other datasets, which is more conducive to the model detecting small targets of space-based ships.

As shown in FIG. 5, compared to other datasets, the ship distribution in the images of the SDG-IRSTD dataset is more uniform. The number of targets in the remaining datasets ranges from 0 to 105, with almost no occurrence of dense or multiple targets. The SDG-IRSTD dataset has more ship intensive scenes and a more uniform distribution of targets, which is crucial for model learning.

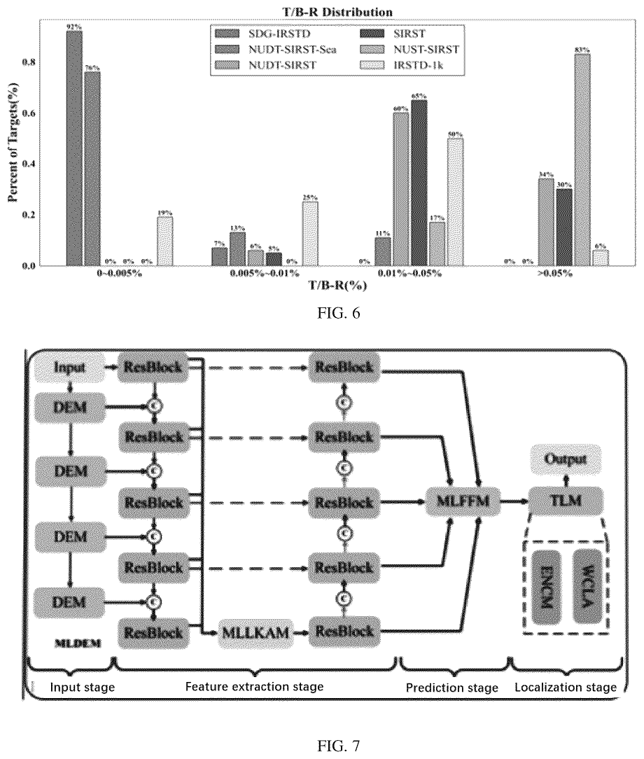

As shown in FIG. 6, 92% of the target background ratios in the SDG-IRSTD dataset are between 0 and 0.005%. The average target background ratio of the SDG-IRSTD dataset is 0.02654%, and the average target background ratio of the SDG-IRSTD dataset is 0.02654%. Compared with other mainstream datasets, the target size in the SDG-IRSTD dataset is relatively smaller, but the overall image size is larger, indicating that the SDG-IRSTD dataset has the smallest average target background ratio. In addition, the SDG-IRSTD dataset has a higher proportion of background and more complex environmental information, which can cover a wider range of application scenarios. The SDG-IRSTD dataset covers various scenarios, such as offshore scenarios, nearshore scenarios, dense cloud interference scenarios, and weak target scenarios. This is due to the high specific heat capacity of water, which causes the sea surface to appear warm toned in thermal infrared images as heat is absorbed, resulting in a smaller difference in radiation between the ship and the sea surface, leading to a weaker brightness of the target. This minimum average target to background ratio and complex environmental information undoubtedly increases the difficulty of ship detection and poses higher challenges for accurate ship detection. However, under such complex dataset conditions, the ship target detection method of this application accurately identifies ship targets, which indirectly proves that this method has better performance compared to other methods.

It can be seen that the present disclosure establishes the first pixel level annotated three-channel infrared ship target detection image dataset based on SDGSAT-1 by combining the thermal infrared image data of SDGSAT-1. Compared to other mainstream datasets, SDG-IRSTD has the highest imaging width, smallest target size, largest image size, and the greatest number of bands, covering a wide range of application scenarios and making it more suitable for infrared small target ship detection tasks. The three thermal infrared bands can not only be displayed synchronously in the image, but also provide sufficient thermal information, which is helpful for subsequent deep learning models to fully extract thermal information and conduct deep learning.

### Example 3

On the basis of Example 1, this Example takes the construction of a 5-layer feature attention mechanism network model as an example. For step S2, a network model based on hierarchical feature attention mechanism is constructed, and the implementation method of using this network model for small target recognition of ships in thermal infrared images is described in detail.

In this Example, for step S21, in the input stage, the obtained three-channel infrared ship target dataset is subjected to multi-level detail enhancement processing to generate feature maps of different scales, specifically:
S211: Build a multi-level detail enhancement mode, with each level adopting a single input dual output processing structure;
S212: At different levels, the first output path does not process the input image and directly sends it to the next level; The second output path will first obtain images of different sizes through downsampling, and then extract local features of different scales from the input images of different sizes through different numbers of residual blocks;
S213: Fuse local features of different scales into images of different sizes, and generate feature maps of different scales at different levels.

In particular, the second output path specifically adopts a dual branch structure, each branch structure includes a different number of residual blocks, and the two branches are used to extract semantic information and detail information of the image, respectively, to enrich the features of the corresponding level.

Specifically, given the input image X∈R^{C×H×W}, where C, H and W denote the channels, height, and width of X. The input of DEM for each stage can be expressed as

$${F}_{i} ∈ {R}^{C \times \frac{H}{{2}^{i - 1}} \times \frac{W}{{2}^{i - 1}}} , i = 1 , 2 , 3 , 4 , 5.$$

Subsequently, these multi-scale images are processed through a dual-branch architecture followed by the element-wise addition to generate feature maps that provide rich detailed information. This design takes advantage of shallow networks in providing low solution fine-grained features to enhance the detailed information of images.

Residual Block is a neural network structure that passes input directly to deep layers through skip connections, making it easier for the network to learn residuals. The skip connections allow gradients to be directly transmitted back to shallow layers, effectively alleviating the problem of gradient vanishing in deep networks. In addition, residual blocks are used here to extract multi-scale features and enhance the ability to preserve detailed information.

This design can enhance the detailed information of the image, which is crucial for the subsequent segmentation of the target. In previous IRSTD tasks, the traditional approach was to directly feed the input image into the backbone network to extract multi-level features, which resulted in insufficient utilization of the input image information. To reduce the computational complexity and extract high-level features, backbone networks often use pooling layers multiple times to sample feature maps. Although this can reduce the size of feature maps, it inevitably results in image information loss that is important for segmentation tasks. In terms of this issue, the present disclosure performs multi-level detail enhancement processing on the input image dataset to generate feature maps of different scales, and supplements low-frequency and high-frequency information of images of different scales through a dual branch structure. This approach can fully explore and utilize image information, and effectively compensate for useful information that may be lost during the downsampling process, providing richer and more accurate data support for the next step of feature extraction.

In this Example, for step S22, in the feature extraction stage, a multi-level encoder large kernel attention mechanism decoder structure pattern is adopted to extract multi-level long-distance information from multi-scale feature maps, and then fuse the long-distance information into feature maps of different scales to generate feature maps of different scales containing long-distance information. The main steps include:
S221: Multi-level encoders encode feature maps of different scales, generating multi-level features to enrich feature representation. In particular, multi-level features include high-resolution low-level features and high-level features of low-resolution, which can achieve high-precision image segmentation.
S222: Merge the multi-level features output by the multi-level encoder with the feature maps of different scales obtained in the input stage in a hierarchical correspondence to obtain a new multi-scale feature map.

Specifically, the input image is expressed as X∈R^{C×H×W}, and the fused i-th scale feature map is expressed as

$${E}_{i} ∈ {R}^{C \times \frac{H}{{2}^{i - 1}} \times \frac{W}{{2}^{i - 1}}} , i = 1 , 2 , 3 , 4 , 5.$$

S223: Extracting multi-level long-distance information from multi-scale feature maps through a multi-level large kernel attention mechanism. Each level of large kernel attention mechanism mainly includes batch normalization (BN) mechanism, large kernel attention mechanism, multi-layer perceptron (MLP), etc. The large kernel attention mechanism refers to the use of convolutions with larger kernels to extract long-distance information. Long distance information refers to the dependency relationship between points that are far apart in a feature map. In particular, each level of large kernel attention mechanism includes the following processing operations:
S2231: Reconstructing multi-scale feature maps through convolutional layers with a stride equal to the size of the convolution kernel to unify the dimensionality of the feature maps and facilitate subsequent fusion. In this Example, the specific formula is:

$${V}_{i} = Conv ( {E}_{i} ; s = ks = {RF}_{i} ) , i = 1 , 2 , 3 , 4 , 5$$

where, Vᵢ denotes the feature map of the i-th scale of the reconstructed output, Eᵢ denotes the i-th scale of the input feature map, RFᵢ denotes the reduction factor of the i-th level feature. Conv denotes the standard convolution, s and ks denote the step size and convolution kernel size, respectively. The reduction factors used for feature maps of different scales are different.
S2232: The reconstructed multi-scale feature map is first batch standardized, and then enters the large kernel attention mechanism for pointwise convolution, large kernel convolution, and pointwise convolution to extract multi-level long-distance information. In the large kernel attention mechanism, the large kernel convolutional attention models long-distance relationships, and the multi-level long-distance information output by the attention mechanism is represented by the following formula.

$${T}_{i} = PW ( LKA ( GELU ( PW ( BN ( {V}_{i} ) ) ) ) ) + {V}_{i} , i = 1 , 2 , 3 , 4 , 5$$

where PW denotes the point-wise convolution; LKA denotes the Large Kernel Convolution; BN denotes the batch normalization, GELU denotes Gaussian Error Linear Unit. In this Example, the large kernel convolution is decomposed into three parts, and the specific calculation formula for the large kernel convolution LKA is expressed as:

$$LKA = DW ( DDW ( PW ( I ) ) ) ⊗ I$$

where I denotes the input of the large kernel convolution, DW denotes a deep convolution with a kernel size of (2d−1)×(2d−1), DDW denotes a deep convolution with a kernel size of

$$⌈ \frac{K}{d} ⌉ \times ⌈ \frac{K}{d} ⌉ ;$$

PW denotes a pointwise convolution with a kernel size of 1×1; D denotes the convolution dilation rate and K is a preset standard parameter.
S2233: Send multi-level long-distance information to multi-layer perceptron for information enhancement. In this Example, the multi-layer perceptron (MLP) includes 1×1 point convolution, 3×3 depth convolution, Gaussian error linear unit, and 1×1 point convolution. The multi-level long-distance information Oi is enhanced by multi-layer perceptron and can be expressed as:

$${O}_{i} = BN ( MLP ( {T}_{i} ) ) + {T}_{i}$$

where Oi denotes the multi-level long-distance information enhanced by multi-layer perceptron information; BN denotes the batch normalization; MLP is a multi-layer perceptron information augmentation operation; Ti is the input multi-level long-distance information.
S224: Multi-level long-distance information will be aggregated into feature maps of different scales through feature concatenation operations, and then sent to multi-level decoders to decode and restore feature maps of different scales, which contain long-distance information.

The present disclosure combines the large kernel attention mechanism with multi-scale features. Feature maps of different scales are extracted with multi-level long-distance information through a multi-level large kernel attention mechanism. The multi-level large kernel attention mechanism can comprehensively capture and utilize global information from multiple levels while reducing computational complexity. It can better utilize local information and long-distance information to improve the segmentation accuracy of the model.

In this Example, for step S23, in the prediction stage, feature maps of different scales containing long-distance information are fused to generate a predicted target probability map. The specific steps are:
S231: Before fusion, in order to maintain dimensional consistency, feature maps of different scales are upsampled to generate feature maps of different scales with unified dimensions;
S232: Use attention mechanism to assign different weights to feature maps of different scales, and add the weighted feature maps element by element to generate the final predicted target probability map. In the specific implementation process, its specific formula is:

$${\hat{D}}_{i} = Upsample ( {D}_{i} ; sf = {RF}_{i} ) , ∀ i$$

$$P = Sigmoid ( {\sum }_{i = 1}^{5} {α}_{i} {\hat{D}}_{i} )$$

where \hat{D}ᵢ denotes the feature map of the i-th scale output after upsampling, Dᵢ denotes the i-th feature map, Upsample denotes upsampling operation, sf represents the upsampling rate, RFᵢ denotes the reduction factor of the i-th level feature, P represents the predicted target probability map of the output; The weight corresponding to the feature map of the i-th scale is represented; Sigmoid is an activation function that maps input data between 0 and 1, obtaining the probability of each pixel being the predicted target.

The weight αᵢ is generated through self-attention mechanism calculation. In the specific implementation process, it can be generated through the convolution layer calculation of 1×1 convolution kernel. The weight α can be expressed as:

$$β = Conv ( Conv ( GAP ( D ) ; k s = 1 ) ; k s = 1 )$$

$$γ = Conv ( Conv ( GMP ( D ) ; k s = 1 ) ; k s = 1 )$$

$$α = γ + β$$

where D denotes the feature maps of different scales, Conv denotes the standard convolution, ks=1 indicates that the size of the convolution kernel is 1×1, GAP denotes the global average pooling, GMP denotes the global maximum pooling, β and γ denote the adaptive parameters used for feature fusion.

Compared to traditional methods that rely solely on the final output of the decoder as the probability likelihood map, the present disclosure fuses the feature maps of different scales output by the decoder to generate the final predicted target probability map, achieving feature fusion and interaction at different scales. This can significantly improve segmentation accuracy and enhance the comprehensive representation ability of details and global information, effectively improving the model's adaptability to complex scenes.

In this Example, for step S24, during the positioning phase, the generated predicted target probability map is used to locate the ship target using the eight connected aggregation algorithm. Specifically:
S241: Generate a binary graph by binarizing the predicted target probability map using a preset threshold. In the specific implementation process, a suitable threshold is pre-set and each pixel in the predicted target probability map is traversed. If the probability value of a pixel is greater than or equal to the threshold, it is assigned a value of 1 (representing the foreground, which may be a ship); If it is less than the threshold, it is assigned a value of 0 (representing the background), thus converting the probability map into a binary map containing only 0 and 1 values.
S242: Use the eight connected aggregation algorithm to count the pixels contained in each ship target in the binary graph, and complete the ship target localization. The specific formula is:

$${N}_{8} ( {pixel}_{1} ) ⋂ {N}_{8} ( {pixel}_{2} ) \neq ϕ$$

where N₈(pixel₁), N₈(pixel₂) denotes the point sets of the eight neighborhoods of the pixel points pixel₁, pixel₂ respectively. Specifically, if two pixels have intersection points within their eight neighborhoods, pixel₁, pixel₂ can be considered an adjacent pixel; If the pixel values of adjacent pixels are equal, pixel₁, pixel₂ can be considered as pixels of the same target. After obtaining the corresponding pixel points of the target, the localization of the ship target can be completed.

In addition, unlike the traditional method of calculating the centroid by averaging the coordinates corresponding to each pixel of the target, the present disclosure further calculates the centroid coordinates of the ship target through a weighted centroid positioning algorithm. The weighted centroid positioning algorithm is as follows. Firstly, based on the already located ship target, the horizontal and vertical coordinate information of all the pixels were obtained. Normalize the pixel values of all pixels of the ship target to obtain weights, and finally calculate the centroid of the ship target based on the weights and the horizontal and vertical coordinate information. The calculation is:

$$c = ( {w}^{T} x , {w}^{T} y )$$

$$w = \frac{v}{{‖ v ‖}_{1}}$$

where x and y represent the horizontal and vertical coordinates of the pixels contained in the ship target, respectively, v represents the pixel value of the pixels in the ship target, and w represents the weight corresponding to the pixels, C represents the center of mass of the ship target.

After generating the predicted target probability map through HFA-Net, a threshold is used to binarize the probability map and the eight connected aggregation algorithm is used to count the pixels contained in each target. If two pixels have intersection points within their eight domains, then these two pixels can be considered adjacent points. If the pixel values of the pixels are equal, then these two pixels can be considered as pixels of the same target. After obtaining the corresponding pixels of the target, the target can be located and the centroid coordinates of the target can be calculated through a weighted centroid positioning algorithm.

In this Example, the hierarchical feature attention network model of the present disclosure adopts a deep supervision strategy to evaluate the model, and a loss function is added to each level of the network model. By utilizing deep supervision, the network model can learn discriminative features at different scales. By measuring the similarity between the predicted target probability map of the model and the true value, the segmentation head is allowed to consider label information at each level. In the specific implementation process, the overall loss function is expressed as follows:

$$L = {\sum }_{i = 1}^{5} {L}_{i} , i = 1 , 2 , 3 , 4 , 5$$

where L denotes the final total loss value; Lᵢ denotes the output loss value of the i-th level decoder.

The present disclosure selects focal loss and dice loss as the loss functions for each stage of the decoder, and the specific calculation formula is as follows:

$${L}_{F} = - {α ( 1 - p )}^{γ} log ( p )$$

$${L}_{D} = 1 - \frac{2 \vert P ⋂ GT \vert + ε}{\vert P \vert + \vert GT \vert + ε}$$

$${L}_{i} = {L}_{F} + {L}_{D}$$

where GT denotes the ground truth, P denotes the predicted target probability map α and γ represent the hyperparameters used to control weights; ε denotes the smoothness factor to avoid oscillation during the training process; p denotes the detection probability corresponding to each pixel.

The present disclosure can aggregate the final output loss values of different network layers through a deep supervision strategy, and pass the loss values to each layer of the model through backpropagation, guiding the model to adjust parameters to reduce losses, making the detection results closer to the true values, improving model performance, enhancing robustness, and making ship detection more accurate.

### Example 4

As shown in FIG. 7, the Example of the present disclosure also provides a micro ship target detection system in thermal infrared images based on hierarchical feature attention network. The system uses the micro ship target detection method in thermal infrared images based on hierarchical feature attention network described in Example 3. The system includes a thermal infrared image data processing module and a ship target recognition module;

The thermal infrared image data processing module preprocesses the image data of the three thermal infrared bands of SDGSAT-1 and outputs a pixel level annotated three-channel infrared ship target detection dataset;

Ship target recognition module, used to construct a network model based on hierarchical feature attention mechanism for thermal infrared image ship small target recognition. The ship target recognition module includes Multi-Level Detail Enhancement Module (MLDEM), Multi Level Large Kernel Module (MLLKAM), Multi Level Feature Fusion Module (MLFFM), and ship target localization module;

Multi-level detail enhancement module (MLDEM) is applied in the input stage to generate feature maps of different scales by performing multi-level detail enhancement processing on the input three-channel infrared ship target dataset;

Multi-level Large Kernel Attention Module (MLLKAM) is applied in the feature extraction stage to extract multi-level long-distance information from input multi-scale feature maps by utilizing multi-level large kernel attention mechanisms. Then, the long-distance information is fused into feature maps of different scales to generate feature maps of different scales containing long-distance information;

Multi-level feature fusion module (MLFFM), applied in the prediction stage, generates a predicted target probability map by fusing input feature maps of different scales containing long-distance information;

The ship target localization module is applied in the positioning stage, using the generated predicted target probability map, using the eight connected aggregation algorithm to locate the ship target, and using the weighted centroid positioning algorithm to locate the centroid coordinates of the ship.

In this Example, the multi-level detail enhancement module is composed of multiple detail enhancement modules (DEM) connected in parallel and introduced into the input stage of the network model. Each detail enhancement module is a single input dual output structure. In particular, one output path does not process the image, but sends it to the next level of detail enhancement module, while the other output path uses a dual branch structure to supplement local features of different scales to enhance the model's detail information. Each branch structure includes a different number of residual blocks, which are used to extract semantic and detailed information of the image separately to enrich the features of the corresponding stage.

In this Example, the multi-level large kernel attention module is a symmetrical multi-level encoder large kernel attention mechanism decoder. In the multi-level large kernel attention module, the multi-level features output by the multi-level encoder are first fused with the feature maps of different scales obtained in the input stage in a hierarchical correspondence to obtain a new multi-scale feature map. Then the multi-scale feature maps enter the multi-level large kernel attention module to extract multi-level long-distance information. The multi-level large kernel attention module is composed of multiple large kernel units (LKABlocks) connected in parallel. Feature maps of different scales enter multiple LKABlocks to extract multi-level long-distance information, which is used to comprehensively capture global information from multiple levels. Each large kernel unit (LKABlock) includes batch normalization (BN) mechanism, large kernel attention mechanism (Attention module), multi-layer perceptron (MLP), etc. In the large kernel unit, multi-scale feature maps are first reconstructed, then long-distance information is extracted through the large kernel attention mechanism, and finally information enhancement is performed through multi-layer perceptron.

Finally, multi-level long-distance information will be aggregated into feature maps of different scales through feature concatenation operations, and then decoded by multi-level decoders to recover feature maps of different scales, which contain long-distance information.

In this Example, the multi-level feature fusion module upsamples the input feature maps of different scales to generate feature maps of different scales with unified dimensions; Using attention mechanism to assign different weights to feature maps of different scales, the weighted feature maps are added element by element to generate the final predicted target probability map.

In this Example, the ship target positioning module utilizes the generated predicted target probability map and uses the eight connected aggregation algorithm to locate the ship target. Based on this, the weighted centroid positioning algorithm is used to locate the centroid coordinates of the ship.

Below, we will compare the detection methods of network models based on hierarchical feature attention mechanism with those of existing publicly available convolutional neural network models, and analyze the detection results of each method. The specific results are shown in Table 3.

TABLE 3

| Method | IoU (×10⁻²) | P_{d} (×10⁻²) | Fₐ (×10⁻⁶) |
|---|---|---|---|
| ACM | 46.50 | 88.97 | 26.91 |
| ALC-Net | 46.09 | 76.21 | 46.34 |
| ResU-Net | 50.42 | 84.31 | 13.10 |
| DNANet | 59.07 | 76.72 | 8.71 |
| ISTDU-Net | 56.07 | 89.66 | 36.19 |
| MTU-Net | 63.26 | 90.34 | 10.54 |
| HFA-Net | 65.61 | 94.31 | 7.25 |

In particular, ACM (see Dai et al., 2021, Asymmetric contextual modulation for infrared small target detection) mainly uses asymmetric context modulation mechanism to achieve small target recognition; ALC Net (see Dai et al., 2021, Attentive local contrast networks for infrared small target detection) primarily utilizes attention mechanisms and local contrast enhancement to achieve small target recognition; ResU Net (see, Diakogiannis et al., 2020, ResUNet-a: A deep learning framework for semantic segmentation of remotely sensed data.) Mainly achieved small target recognition through a deep learning model that combines U-Net and Residual Network (ResNet); DNANet (see Li et al., 2022, Dense nested attention network for infrared small target detection) primarily achieves small target recognition through a densely nested attention mechanism; ISTDU Net (see Hou et al., 2022, ISTDU Net: infrared small target detection U-Net) mainly utilizes U-Net and infrared image characteristics to detect and locate infrared small targets; MTU Net (see Wu et al., 2023, MTU Net: multilevel TransUNet for space-based infrared tiny ship detection) mainly achieves ship target recognition through a multi-level self-attention U-shaped network; HFA-Net (Hierarchical feature attention network) is a network model based on hierarchical feature attention mechanism proposed in this application. Through a hierarchical feature attention mechanism, it effectively captures and utilizes multi-scale features and contextual information in images to complete detection tasks. IoU is the intersection to union ratio, which represents the degree of overlap between the predicted box and the real box; Pa is the detection probability, which refers to the probability of correctly detecting the target; Fₐ is the false alarm rate, which represents the probability of incorrectly detecting the target.

From the quantitative experimental results in Table 3, it can be observed that the detection performance of the HFA-Net model of the present disclosure has been significantly improved compared to other methods. The IoU, P_{d}, and Fₐ of HFA-Net are 65.61%, 94.31%, and 7.25×10⁻⁶, respectively. From a suboptimal comparison, the HFA-Net model shows a significant improvement in detection performance compared to MTU Net, with improvements of 2.35% and 3.97% in IoU and Pa, respectively, and a decrease of 3.29×10⁻⁶ in Fₐ. This is because the HFA-Net model fully extracts and utilizes multi-level features. In the input stage of the network model, the multi-level detail enhancement module (MLDEM) is used to fuse local features of different scales with images of different sizes output by the corresponding stage of the backbone network, generating feature maps of different scales and enhancing the representation of detail information at different scales. In the feature extraction stage, multi-level large kernel attention module (MLLKAM) is used to extract multi-level long-distance information, allowing the model to learn the relationship between the target and the background at different scales. In the final prediction stage, the present disclosure can learn the influence of different scales on the probability likelihood map through a multi-level feature fusion module (MLFFM).

In addition, to further demonstrate and analyze the impact of various modules introduced in the HFA-Net model on ship segmentation performance, the present disclosure conducted experiments on the SDG-IRSTD dataset using different parameter configurations, and analyzed the impact of each module (MLDEM, MLLKAM, MLFFM) on accuracy based on the results of different network configurations. The specific results are shown in Table 4.

TABLE 4

| Method | IoU (×10⁻²) | Pa (×10⁻²) | Fa (×10⁻⁶) |
|---|---|---|---|
| w/o MLDEM | 64.16 | 92.06 | 7.63 |
| w/o MLLKAM | 63.98 | 93.97 | 11.77 |
| w/o MLFFM | 64.51 | 92.93 | 10.05 |
| HFA-Net | 65.61 | 94.31 | 7.25 |

As shown in Table 4, removing any module will reduce the overall performance of the HFA-Net model to varying degrees. In particular, removing MLLKAM has the greatest impact on the IoU index, resulting in a 1.63% decrease in the IoU of the HFA-Net model. Other indicators also show varying degrees of decline, with Pa decreasing by 0.34% and Fₐ increasing by 4.52×10⁻⁶. This is because MLLKAM can extract multi-level long-distance information from remote sensing images and effectively utilize it, making up for the shortcomings of convolutional neural network models that only focus on local features, effectively suppressing the interference of background on ship detection, and fully demonstrating the importance of multi-scale long-distance information for infrared ship detection. Excluding other modules, the performance of HFA-Net will also be affected to varying degrees, further demonstrating the reliability of MLDEM, MLLKAM, and MLFFM in IRSTD tasks.

Through the above experiments, it can be seen that the present disclosure combines all bands of SDGSAT-1 TIS to establish a pixel level annotated three-channel infrared ship target detection dataset (SDG-IRSTD). Compared with other mainstream datasets, SDG-IRSTD has the highest imaging width, smallest target size, largest image size, smallest average target to background ratio, most complex observation scenes, and the largest number of bands, making it more suitable for detecting small ship targets in thermal infrared images. This dataset can fully extract thermal information from remote sensing images, assisting deep learning networks. In addition, the proposed HFA-Net generates feature maps of different scales through MLDEM, then uses MLLKAM to extract long-distance information of multi-level features, and finally achieves feature fusion and interaction of different scales through MLFFM. Compared with the MTU Net method, HFA-Net improved IoU and P_{d} by 2.35% and 3.97% respectively, and reduced Fₐ by 3.29×10⁻⁶. The experimental results verified the superiority of the method proposed in this disclosure. This method can achieve accurate target positioning while synchronously obtaining the overall contour of the ship, providing a reliable method for sustainable development goals and subsequent research in the field of ocean management.

The above description is only an embodiment of the present disclosure and is not intended to limit the present disclosure. Any modifications, equivalent substitutions, and improvements made within the scope of the present disclosure shall be included in the scope of protection of the present disclosure.

What is claimed is:

1. A method for detecting small ship targets in thermal infrared images based on hierarchical feature attention network, comprising the following steps:
S1: collecting and preprocessing image data of detection areas in three thermal infrared bands of Sustainable Development Goals Science Satellite 1 (SDGSAT-1) to establish a pixel level annotated three-channel infrared ship target detection dataset; and
S2: constructing a network model based on hierarchical feature attention mechanism for thermal infrared image ship target identification, wherein the thermal infrared image ship target identification is divided into four stages: input stage, feature extraction stage, prediction stage, and localization stage; wherein the step S2 comprises:
S21: in the input stage, performing a multi-level detail enhancement process on the three-channel infrared ship target detection dataset to generate feature maps of different scales;
S22: in the feature extraction stage, extracting multi-level long-distance information from multi-scale feature maps, and fusing the multi-level long-distance information into the feature maps of different scales to generate feature maps of different scales containing the multi-level long-distance information;
S23: in the prediction stage, fusing the feature maps of different scales containing the multi-level long-distance information to generate predicted target probability maps; and
S24: in the localization stage, performing a ship target localization through an eight connected aggregation algorithm with the predicted target probability maps.

2. The method for detecting small ship targets in thermal infrared images based on hierarchical feature attention network according to claim 1, wherein the step S1 comprises:
S11: collecting thermal infrared image data from the three thermal infrared bands of the SDGSAT-1 simultaneously, combining the three thermal infrared bands to form a three-channel thermal infrared image dataset;
S12: performing a radiometric calibration on the three-channel thermal infrared image dataset to generate a three-channel thermal infrared image dataset with amplitude and brightness values; and
S13: annotating a ship target of the three-channel thermal infrared image dataset with a Segment Anything Model (SAM) model to obtain the pixel level annotated three-channel infrared ship target detection dataset, wherein each image in the three-channel thermal infrared image dataset is a three-channel image composed of the three thermal infrared bands.

3. The method for detecting small ship targets in thermal infrared images based on hierarchical feature attention network according to claim 1, wherein the step S21 comprises:
S211: constructing a multi-level detail enhancement module with a single input dual output process structure for each level;
S212: at different levels, sending, by a first output path, an input image to a next level without processing, obtaining, by a second output path, images of different sizes through downsampling, and then extracting local features of different scales from the images of different sizes through different numbers of residual blocks; and
S213: fusing the local features of different scales to generate the feature maps of different scales at different levels.

4. The method for detecting small ship targets in thermal infrared images based on hierarchical feature attention network according to claim 3, wherein the second output path is a dual branch structure, each branch structure of the dual branch structure comprises a different number of the residual blocks for extracting semantic and detail information of images, respectively.

5. The method for detecting small ship targets in thermal infrared images based on hierarchical feature attention network according to claim 1, wherein for the step S22, in the feature extraction stage, a multi-level encoder large kernel attention mechanism decoder structure pattern is adopted, and the step S22 comprises:
S221: encoding, by the multi-level encoder, the feature maps of different scales to generate multi-level features;
S222: fusing the multi-level features output by the multi-level encoder with the feature maps of different scales obtained in the input stage correspondingly by level to obtain the multi-scale feature maps;
S223: extracting the multi-level long-distance information from the multi-scale feature maps through the multi-level encoder large kernel attention mechanism; and
S224: aggregating the multi-level long-distance information into the feature maps of different scales through feature concatenation operations, and decoding and restoring to the feature maps of different scales containing the multi-level long-distance information by the multi-level decoder.

6. The method for detecting small ship targets in thermal infrared images based on hierarchical feature attention network according to claim 5, wherein for the step S223, a large kernel attention mechanism of each level corresponding to the multi-level encoder large kernel attention mechanism comprises:
S2231: reconstructing the multi-scale feature maps using convolutional layers with a stride equal to a size of convolution kernel to unify a dimension of the multi-scale feature maps according to:
$${V}_{i} = Conv ( {E}_{i} ; s = ks = {RF}_{i} ) .$$
to yield a reconstructed multi-scale feature map, wherein, Vᵢ denotesa feature map of i-th scale output by the reconstructing, Eᵢ denotes an input feature map of the i-th scale, RFᵢ denotes a reduction factor of an i-th level feature, wherein the reduction factor used for the feature maps of different scales are different, Conv denotes a standard convolution, s and ks denote the stride and the size of convolution kernel, respectively;
S2232: the reconstructed multi-scale feature map is subjected to batch normalization at first, and then the large kernel attention mechanism is processed for pointwise convolution, large kernel convolution, and pointwise convolution again to extract the multi-level long-distance information; the large kernel convolution is decomposed into three parts, and a large kernel attention (LKA) calculation formula for the large kernel convolution is:
$$LKA = DW ( DDW ( PW ( I ) ) ) ⊗ I$$
wherein, I denotes an input of the large kernel convolution, DW denotes a deep convolution with a kernel size of (2d−1)×(2d−1), DDW denotes a deep convolution with a kernel size of
$$⌈ \frac{K}{d} ⌉ \times ⌈ \frac{K}{d} ⌉ ;$$
PW denotes a pointwise convolution with a kernel size of 1×1; D denotes a convolution dilation rate, and K is a preset standard parameter; and
S2233: sending the multi-level long-distance information to a multi-layer perceptron for information enhancement, wherein the multi-layer perceptron comprises 1×1 point convolution, 3×3 depth convolution, Gaussian error linear unit, and 1×1 point convolution.

7. The method for detecting small ship targets in thermal infrared images based on hierarchical feature attention network according to claim 1, wherein the step S23 comprises:
S231: upsampling the feature maps of different scales to generate feature maps of different scales with a unified dimension; and
S232: assigning different weights to the feature maps of different scales with the unified dimension with the attention mechanism, and adding weighted feature maps element by element to generate a final predicted target probability maps, wherein a calculation formula of a weight α is:
$$β = Conv ( Conv ( GAP ( D ) ; k s = 1 ) ; k s = 1 )$$
$$γ = Conv ( Conv ( GMP ( D ) ; k s = 1 ) ; k s = 1 )$$
$$α = γ + β$$
wherein, D denotes the feature maps of different scales, Conv denotes a standard convolution, ks=1 indicates that a size of a convolution kernel is 1×1, GAP denotes a global average pooling, GMP denotes a global maximum pooling, β and γ denote adaptive parameters used for feature fusion.

8. The method for detecting small ship targets in thermal infrared images based on hierarchical feature attention network according to claim 1, wherein the step S24 is specifically:
S241: performing a binary processing of the predicted target probability map using a preset threshold to generate a binary map; and
S242: counting pixels contained in each ship target in the binary map through the eight connected aggregation algorithm to complete the ship target localization.

9. The method for detecting small ship targets in thermal infrared images based on hierarchical feature attention network according to claim 1, wherein based on a determination of a ship target, calculating and determining centroid coordinates of the ship target with a weighted centroid location algorithm, wherein the weighted centroid location algorithm is comprises: obtaining horizontal and vertical coordinate information of all pixels contained in the ship target, normalizing pixel values of all pixels of the ship target to obtain weights, and calculating the centroid coordinates of the ship target based on the weights and the horizontal and vertical coordinate information.

10. A system for detecting small ship targets in thermal infrared images based on hierarchical feature attention network using the method for detecting small ship targets in thermal infrared images based on hierarchical feature attention network according to claim 1, comprising a thermal infrared image data processing module and a ship target recognition module;
the thermal infrared image data processing module preprocesses the image data of the three thermal infrared bands of the SDGSAT-1 and outputs the pixel level annotated three-channel infrared ship target detection dataset;
the ship target recognition module is configured to construct the network model based on hierarchical feature attention mechanism for thermal infrared image ship target recognition, and comprises a multi-level detail enhancement module, a multi-level large kernel attention module, a multi-level feature fusion module, and a ship target positioning module;
the multi-level detail enhancement module is applied in the input stage and generates the feature maps of different scales by performing a multi-level detail enhancement processing on the three-channel infrared ship target detection dataset;
the multi-level large kernel attention module is applied in the feature extraction stage and extracts the multi-level long-distance information from the multi-scale feature map with a multi-level large kernel attention mechanism, and then fuses the long-distance information into the feature maps of different scales to generate the feature maps of different scales containing multi-level long-distance information;
the multi-level feature fusion module is applied in the prediction stage and generates the predicted target probability map by fusing the feature maps of different scales containing multi-level long-distance information;
the ship target positioning module is applied in the localization stage and locates a ship target by using the predicted target probability map with the eight connected aggregation algorithm, and locates centroid coordinates of the ship target with a weighted centroid positioning algorithm.
